(19) United States
(12) Patent Application Publication
(10) Pub. No.: US 2025/0050268 A1
(43) Pub. Date: Feb. 13, 2025

(54) FACILITY FOR COOLING A GAS FLOW CONTAINING CO2 AND METHOD USING SUCH A FACILITY

(71) Applicant: L'Air Liquide, Societe Anonyme pour l'Etude et l’Exploitation des Procedes Georges Claude, Paris (FR)

(72) Inventors: Michael TRAN, Champigny Sur Marne (FR); Mathieu LECLERC, Champigny Sur Marne (FR); Gian Luigi CALORO, Champigny Sur Marne (FR); Achraf HARBAL, Champigny Sur Marne (FR)

(73) Assignee: L'Air Liquide, Societe Anonyme pour l'Etude et l’Exploitation des Procedes Georges Claude, Paris (FR)

(21) Appl. No.: 18/721,185

(22) PCT Filed: Nov. 22, 2022
(86) PCT No.: PCT/EP2022/082837

§ 371 Date: Jun. 17, 2024

(30) Foreign Application Priority Data
Dec. 17, 2021 (FR) FR2113862

(51) Int. Cl. B01D 53/18; B01D 46/00; B01D 53/14

(52) U.S. Cl. CPC B01D 53/18; B01D 46/0036; B01D 53/1418; B01D 2252/103; B01D 2256/22; B01D 2259/65

(57) ABSTRACT

A facility for cooling a gas flow containing CO2, water and at least one other component includes a scrubbing tower, a pipe for conveying the gas flow at a first temperature to the bottom of the tower, a pipe for conveying water at a second temperature, which is lower than the first temperature, to a first level at the top of the scrubbing tower, a pump, a pipe being connected to the tank of the column for removing tank water and to the pump for pressurizing the water removed from the tank, and means for withdrawing water downstream of the pump, these means being connected to the tower thereby conveying the pressurized water at a third temperature to an indirect heat exchanger located in the tower at the second level above the first level, the third temperature being higher than the second temperature, but lower than the first temperature.

### CROSS-REFERENCE TO RELATED APPLICATIONS

This application is a § 371 of International PCT Application PCT/EP2022/082837, filed Nov. 22, 2022, which claims § 119 (a) foreign priority to French patent application FR 2113862, filed Dec. 17, 2021.

### BACKGROUND

The present invention relates to an installation for cooling a gas stream, containing CO₂, water and at least one other component, and to a cooling method implementing such an installation. The cooling is carried out by water scrubbing and can also have the effect of purifying the gas stream, by removing a portion of the gaseous impurities and/or particles that it contains.

### FIELD OF THE INVENTION

Containing CO₂ is understood to mean a content of CO₂ greater than 10 mol % on a dry basis.

In order to reduce emissions of CO₂ of human origin into the atmosphere, processes for capturing the CO₂ generated in a given process have been developed. It is a question of extracting the CO₂ from a gas generated by the process, purifying it and finally, in general, compressing it in order to transport it in a pipeline. This treatment often requires the gas to be cooled and/or purified in a water scrubbing tower.

### RELATED ART

Gas streams treated in CO₂ capture processes are usually available at high temperatures and low pressures close to atmospheric pressure. Before any treatment, it is necessary to cool them, usually by direct contact with water as described in EP0503910 since this solution makes it possible to minimize the pressure drops. If a filter is used downstream of this scrubbing tower (in the case of particle-laden gas streams such as those generated by cement or lime production or by generation of electricity from coal, for example), the gas stream has to be overheated relative to its dew point in order to avoid the formation of a wet “cake” on the walls of the filter, which would clog it and could potentially block its regeneration in the case of dynamic filters. The present invention proposes an optimized solution for carrying out this overheating.

### SUMMARY OF THE INVENTION

FIG. 1 shows a water scrubbing process for purifying a CO₂-rich flow 1 for example comprising at least 10 mol % on a dry basis, and also water and at least one other component, for example nitrogen, oxygen, argon, optionally solid impurities, in particulate form such as dust and optionally acidic compounds, for example NOₓ, SOₓ, halogenated compounds.

The flow 1 at a high temperature and at a pressure close to atmospheric pressure is scrubbed in a scrubbing column 3 by means of a flow of water 13. The water 13 is sent to the top of the column so as to cool the gas and to abate impurities present in the gas 1 so as to produce a purified gas 17 at between 5 and 70° C., i.e. at its dew point, and a bottom liquid 5, mainly water, which is pressurized by a pump 7, heated and divided into two. A portion 11 is taken to be purified and the remainder 13 is sent after expansion in a valve 15 to the top of the column 3.

The purified portion may be recycled (not shown) after purification so as to supply various circuits of the process or may be evacuated to the outside of the installation.

It is known from “Steam: Its Generation and Use” 41^{st} edition, 2005, Babcock and Wilcox, to heat the gas cooled in a scrubbing tower so as to avoid deposits of sulfuric acid on the walls of the ducts downstream of the tower. The use of steam for heating within a heat exchanger is mentioned.

It would be possible to conceive of heating the gas coming from the scrubbing tower by virtue of heat exchangers directly installed in the upper part of the scrubbing tower, after the heat exchange by scrubbing with the water. This solution would make it possible to minimize the pressure drops compared with a solution involving a dedicated heat exchanger. In addition, in order to minimize the size of these exchangers (and therefore to minimize the pressure drops induced on the gas stream side), the hot fluid selected would be condensing steam (for a greater thermal intensity per unit area) or very hot water.

In other cases, when steam or very hot water is not available, electric heat exchangers could be used in order to carry out this overheating, for the same reasons (high thermal intensity and therefore small pressure drops).

When steam or very hot water is absent, the use of electrically heated heat exchangers very significantly increases the electrical consumption of the unit as a result of the high flow to be heated. This may make this solution prohibitive.

One object of the invention is to reduce the heating cost of the installation.
Another object of the invention is to reduce the electrical consumption of the process.

The invention makes it possible to heat a gas stream with an energy cost of almost zero while at the same time ensuring very small pressure drops in the gas stream since the latter has to be compressed in a compressor for carrying out the additional treatments and separations. A high pressure drop implies a greater energy consumption during compression and also an increase in the size of the compressor and thus its investment cost.

According to one subject of the invention, there is provided an installation for cooling a gas stream, containing CO₂, water and at least one other component, comprising a scrubbing tower, a duct for sending the gas stream at a first temperature to the bottom of the tower, a duct for sending water at a second temperature, which is lower than the first temperature, to a first level at the top of the scrubbing tower, a pump, a duct being connected to the bottom end of the column so as to remove the bottom water and to the pump so as to pressurize the water removed from the bottom end, characterized in that it comprises means for withdrawing water downstream of the pump, these means being connected to the tower so as to send the pressurized water at a third temperature to an indirect heat exchanger located in the tower at a second level above the first level, the third temperature being higher than the second temperature but lower than the first temperature.

According to other optional aspects:
the installation comprises a heater, the means connected to the tower so as to send the pressurized water at the third temperature to the indirect heat exchanger being connected to the heater so as to send water pressurized by the pump thereto and so as to send the water heated in the heater to the indirect heat exchanger.
the tower comprises mass and heat exchange elements disposed below the first level and between the first and second levels but preferably not above the second level.

According to another subject of the invention, there is provided a method for cooling a gas stream, containing CO₂, water and at least one other component, wherein the gas stream is sent at a first temperature to the bottom of a scrubbing tower, the stream is scrubbed with water sent to a first level at the top of the scrubbing tower at a second temperature, which is lower than the first temperature, gas at least partially purified of water is removed at the top of the tower at a temperature lower than the first temperature and preferably at a temperature higher than its dew point, water is removed at the bottom end of the scrubbing tower and pressurized in a pump, water pressurized by the pump is sent, without having been cooled, at a third temperature to an indirect heat exchanger located in the tower at a second level above the first level, the third temperature being higher than the second temperature but lower than the first temperature, the first portion of the water being cooled in the indirect heat exchanger in order to introduce heat at the top of the scrubbing tower.

According to other optional aspects:
at least a portion of the water cooled in the heat exchanger is mixed with water pressurized and cooled in a cooler and is preferably sent to a treatment unit.
the gas removed at the top of the tower is sent to a filter so as to remove solid impurities.
the installation does not comprise means for heating the water sent to the heat exchanger downstream of the pressurization so as to reach the third temperature.
the installation comprises means for heating the water sent to the heat exchanger downstream of the pressurization so as to reach the third temperature.
the installation does not comprise means for cooling the water sent to the heat exchanger downstream of the pressurization so as to reach the third temperature.
the water sent to the heat exchanger comes from a store.
a duct connects the heat exchanger and the outlet of the pump.
the water sent to the heat exchanger is heated downstream of the pressurization so as to reach the third temperature.
the water sent to the heat exchanger is heated by indirect heat exchange with the gas filtered in the filter and then compressed in a compressor.
the water sent to the heat exchanger is heated by indirect heat exchange with the gas stream upstream of the tower.
the water sent to the first level at the top of the scrubbing tower at the second temperature has been previously treated by addition of a chemical reagent such as caustic soda or sodium bicarbonate.
the first temperature is between 100 and 200° C.
the second temperature is between 3° C. and 37° C.
the third temperature is between 40 and 115° C.
the third temperature is between 40 and 95° C.
the second and third temperatures differ by at least 30° C., or even by at least 60° C.
the pressure of the gas stream arriving at the base of the tower is between 0.9 and 2.0 bara.
the water is pressurized by the pump to a pressure between 2.0 and 10.0 bara.
gas at least partially purified of water is removed at the top of the tower at a temperature that is higher than its dew point by between 5 and 15° C., preferably by 10° C.
a portion of the water removed at the bottom end of the tower and pressurized is cooled so as to form the scrubbing water sent to the first level

a cooler serves to cool the water sent to the first level down to the second temperature.

The invention consists mainly of:
Recovering at least a portion of the water at the bottom end of the scrubbing tower, at approximately 50-80° C. This water could be sent to the top end of the column so as to carry out the cooling within the scrubbing tower. However, in the context of the invention, it is recovered before cooling (or without cooling if the cooler is not present). This water is available at a pressure very close to that of the gas stream at the inlet of the scrubbing tower.
Pumping this water in the pressure range 0.9-2.0 bara to a pressure range of 2.0-10.0 bara
Injecting it into a heat exchanger at the top end of the scrubbing tower in order to heat, by about 5 to 15° C. and preferentially 10° C., the gas stream at the outlet of the scrubbing tower available between 5 and 70° C.

It may prove that the temperature of this partially heated water is too low and that the quantity to be injected into the heat exchanger is very high in order to ensure the desired heat exchange. This can occur when the gas streams 1 are relatively cold (in winter for example) and can only heat the water very partially. In this case, it is necessary to multiply the heat exchangers, and this increases the pressure drops on the gas stream side, making them too high. In order to reduce the flow of water and therefore limit the number of heat exchangers, it is then necessary to increase the temperature of the water before injection into the heat exchangers. To do this, a plurality of solutions are conceivable, in order of interest:
heating of the partially hot water against the gas streams that are compressed downstream of the filter. In this case, the pressurized water partially replaces the cooling water within one or more coolers of the compressor. The heat is therefore free since it is fatal since it comes from the compression energy. Since the compressed gas streams can reach 50 to 120° C., the pressurized water can therefore reach 45 to 115° C. Since the pressurized water does not make it possible to cool as much as cooling water, it is important to note that the cooling of the compressed gas streams can be supplemented by cooling water. In a sub-variant, the cooling of the compressed gas stream by the pressurized water and cooling water can take place in one and the same exchanger. This therefore limits the investment of this thermal integration.
heating of the pressurized water against the gas streams upstream of the scrubbing tower, which are typically between 100 and 200° C. The heat is also free there since it is normally dissipated in the scrubbing tower. On the other hand, this solution involves pressure drops on the gas stream side.

Beyond heating with a negligible energy cost, this solution is also very economical since the number of necessary items of equipment is small: only the heat exchanger at the top end of the scrubbing tower and possibly the heat exchanger with the compressed gas stream are to be provided.

### BRIEF DESCRIPTION OF THE FIGURES

The invention will be described in more detail with reference to the figures.

FIG. 1 shows a water scrubbing process for purifying a CO₂-rich flow 1.

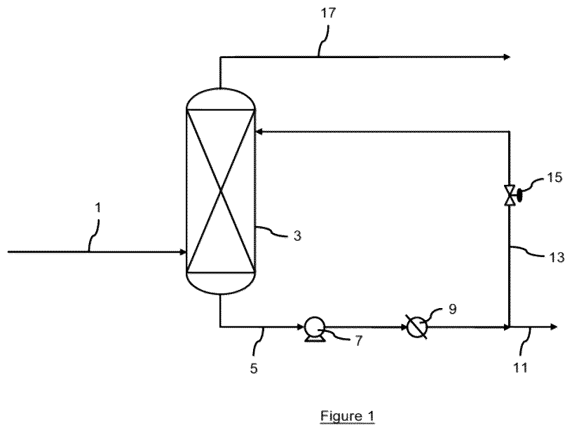

FIG. 2 represents an installation for cooling a gas stream in a water scrubbing tower.

FIG. 3 represents a variant of FIG. 2.

### DETAILED DESCRIPTION OF THE INVENTION

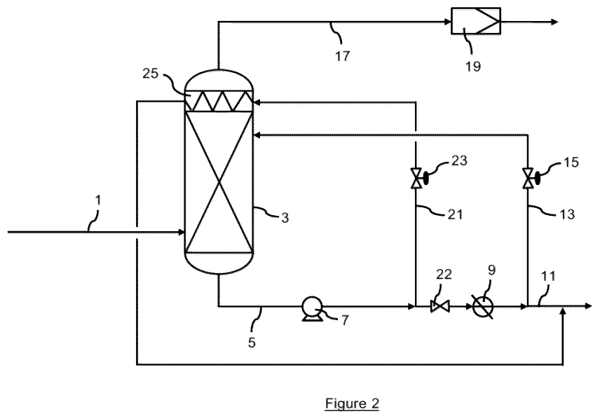

FIG. 2 illustrates a water scrubbing tower 3 supplied at the bottom end by a gas stream 1 having a CO₂ content of at least 10 mol % on a dry basis. The gas stream contains water and at least one other component, for example a NOₓ, a SOₓ, nitrogen, oxygen, argon, hydrogen, carbon monoxide and solid impurities in particulate form such as dust. The gas stream arrives in the tower at a pressure close to atmospheric pressure, for example 0.9-2.0 bara and at a pretemperature between 100 and 200° C.

The tower contains means for promoting heat and mass exchange, for example structured packings. The gas stream rises in the tower and is cooled by direct contact with the water. The water 5 at the bottom end of the tower comprises a large portion of the water contained in the gas stream 1 and may contain solid impurities and/or components of the gas stream that are absorbed by the water. The water 5 is at a temperature between 40 and 95° C., preferably between 50 and 80° C.

The water 5 is pressurized by a pump 7 to a pressure between 2.0 and 10.0 bara and then divided into two portions without having been heated other than by the pumping and without having been cooled. A first portion 21 is sent through a regulating valve 23 into an indirect heat exchanger disposed in the scrubbing tower, at a second level, preferably above the means for promoting mass and heat exchange. The water in the exchanger 25 is at a third temperature between 40 and 95° C. when it arrives in the exchanger 25 where it is cooled by heating the gas stream rising in the tower 3, and the heated stream 17 leaves the tower and is sent to a filter 19 so as to remove the solid impurities that it contains, these impurities possibly having existed in the stream 1 or having been recovered or produced in the tower 3.

The temperature of the water 21 makes it possible to heat the gas stream rising in the column so that the gas stream 17 leaving the tower is increased by between 5 and 15° C. and preferentially by 10° C., the gas stream 17 at the outlet of the scrubbing tower 3 being available between 5 and 70° C. in the preceding case in which the gas stream is not heated at the top of the tower. Thus, the gas stream 17 is at between 5 and 15° C., preferably at 10° C., above its dew point.

The second portion of the pumped water passes through a regulating valve 22 and is cooled by a cooler 9 before being divided so as to form a flow 13 and a flow 11. The flow 13 is sent via a regulating valve 15 to the scrubbing tower at a first level below the second level, which is the point of arrival of the first portion 21.

The water 13 sent to the first level at the top of the scrubbing tower 3 at the second temperature has been previously treated by addition of a chemical reagent such as caustic soda or sodium bicarbonate. This increases the pH of the water and ensures SOₓ abatement, in particular when this water comes from the bottom end of the tower, as illustrated in the example.

The second and third temperatures preferably differ by at least 30° C., or even by at least 60° C.

The water 21 cooled in the heat exchanger 25 is mixed with the flow 11. Since it is still at an excessively high temperature, the water 21 cooled in the exchanger 25 is not used for scrubbing.

Mass and heat exchange elements are disposed below the first level and between the first and second levels but preferably not above the second level.

The indirect heat exchanger 25 is preferably of the hairpin heat exchanger type, the water circulating in the one or more tubes and exchanging heat with the gas in contact with the one or more external walls of the one or more tubes.

In this example the water used for scrubbing comes from the bottom end of the tower. However, it is possible to use water that comes from another source, such as a store, as scrubbing water.

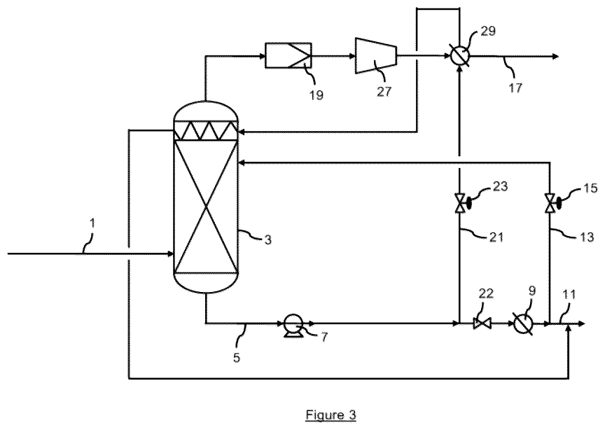

In the variant in FIG. 3, the first portion of the water 21 is not sent directly to the scrubbing tower 3 but recovers heat by indirect heat exchange in a heat exchanger 29 downstream of a compressor 27. The compressor 27 serves to compress the gas stream 17 leaving the filter 19 and the compression heat generated serves to heat the first portion of the water 21 upstream of it being sent to the heat exchanger 25. Since the gas stream leaving the compressor 27 is at between 50 and 120° C., the water 21 heated by this compressed gas stream can therefore reach between 45 and 115° C. Thus, the gas stream 17 is at between 5 and 15° C., preferably at 10° C., above its dew point.

The compressed gas 17 is preferably sent to another cooler if the heat exchange with the water 21 is not sufficient to cool it.

As indicated, this solution is particularly useful when the gas stream is at a relatively low temperature, for example in winter.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”. “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-10. (canceled)

11. An installation for cooling a gas stream, containing CO₂, water and at least one other component, comprising:
a scrubbing tower,
a duct configured to send the gas stream at a first temperature to the bottom of the tower,
a duct configured to send water at a second temperature, which is lower than the first temperature, to a first level at the top of the scrubbing tower,
a pump,
a duct being connected to the bottom end of the column and configured to remove the bottom water and to the pump so as to pressurize the water removed from the bottom end,.
a withdrawing means for withdrawing water downstream of the pump, the withdrawing means being connected to the tower and configured to send the pressurized water at a third temperature to an indirect heat exchanger located in the tower at a second level above the first level, the third temperature being higher than the second temperature but lower than the first temperature.

12. The installation as claimed in claim 11, further comprising a heater, the withdrawing means being connected to the heater and configured to send water pressurized by the pump thereto and configured to send the water heated in the heater to the indirect heat exchanger.

13. The installation as claimed in claim 11, wherein the tower comprises mass and heat exchange elements disposed below the first level and between the first and second levels.

14. A method for cooling a gas stream, containing CO₂, water and at least one other component, comprising.
sending the gas stream at a first temperature to the bottom of a scrubbing tower,.
scrubbing the stream with water sent to a first level at the top of the scrubbing tower at a second temperature, which is lower than the first temperature,.
removing gas at least partially purified of water at the top of the tower at a temperature lower than the first temperature,
water is removed at the bottom end of the scrubbing tower and pressurized in a pump,.
the water pressurized by the pump is sent, without having been cooled, at a third temperature to an indirect heat exchanger located in the tower at a second level above the first level,
wherein the third temperature is higher than the second temperature but lower than the first temperature, and
wherein the first portion of the water is cooled in the indirect heat exchanger in order to introduce heat at the top of the scrubbing tower.

15. The method as claimed in claim 14, wherein at least a portion of the water cooled in the heat exchanger is mixed with water pressurized and cooled in a cooler.

16. The method as claimed in claim 14, wherein the gas removed at the top of the tower is sent to a filter thereby removing solid impurities.

17. The method as claimed in claim 14, wherein the water sent to the heat exchanger is not heated downstream of the pressurization so as to reach the third temperature.

18. The method as claimed in claim 14, wherein the water sent to the heat exchanger is heated downstream of the pressurization so as to reach the third temperature.

19. The method as claimed in claim 16, wherein the water sent to the heat exchanger is heated by indirect heat exchange with the gas filtered in the filter and then compressed in a compressor.

20. The method as claimed in claim 18, wherein the water sent to the heat exchanger is heated by indirect heat exchange with the gas stream upstream of the tower.
